(19) United States
(12) Patent Application Publication
(10) Pub. No.: US 2016/0378101 A1
(43) Pub. Date: Dec. 29, 2016

(54) METHODS, APPARATUSES AND SYSTEMS FOR CONTROLLING A VALVE BASED ON A COMBINATION OF A CHARACTERISTIC CURVE FOR THE VALVE AND A PROPORTIONAL, INTEGRAL AND DERIVATIVE SIGNAL VALVE

(71) Applicant: TESCOM CORPORATION, Elk River, MN (US)

(72) Inventor: Christian Leonard, Hanover (DE)

(21) Appl. No.: 15/159,246

(22) Filed: May 19, 2016

Related U.S. Application Data
(60) Provisional application No. 62/185,037, filed on Jun. 26, 2015.

(51) Int. Cl. G05B 19/4155

(52) U.S. Cl. CPC G05B 19/4155; G05B 2219/37591

(57) ABSTRACT

A process device control may use a combination of a characteristic curve for the device and a proportional, integral and derivative signal value. The characteristic curve for the device may define operational characteristics of the process device. The proportional, integral and derivative signal value may be representative of process device operational deviations from the characteristic curve.

### CROSS-REFERENCE TO RELATED APPLICATIONS

This application claims the benefit of U.S. Provisional Application No. 62/185,037 (filed Jun. 26, 2015). The entirety of the foregoing provisional application is incorporated by reference herein.

### TECHNICAL FIELD

The present disclosure relates to control of process devices used in process plants. More particularly, the present disclosure relates to control of process devices using a combination of a characteristic curve for the device and a proportional, integral and derivative signal value.

### BACKGROUND

Modern process plants (e.g., petroleum processing plants, chemical processing plants, power generation plants, food processing plants, etc.) include a host of process devices (e.g., sensors, valves, transmitters, positioners, etc.) which perform a physical function within associated processes and/or which measure a process variable. Control systems of process devices typically include closed loop controls (e.g., proportional-integral-derivative (PID)) controls.

A common problem using closed loop pressure controls occurs if the control loop is interrupted in some step(s) of an associated operation cycle. For example, interruptions often occur, during process plant startup, when inlet and/or outlet valves are closed, and when an associated pressure source has not yet reached full output. Interruptions may also occur, for example, in back pressure applications, when a process and/or pump has not reached a full flow, or when a paralleled process consumes available media flow.

In each of these interruption circumstances, an associated process device controller is often not able to keep process pressure at a desired set point. Thus, the control pressure may rise or fall to a maximum or a minimum value, respectively, and an associated control loop may be far from a stable operating point. Therefore, when the given interruption is rectified, the process device controller requires time to reach a stable operating point (e.g., load/unload an associated air loader volume), resulting in a significant overshoot or pressure drop during an associated transition phase.

In many case this process device over/under pressure is highly undesirable, and can overload or even destroy a product. Moreover, a process device over/under pressure can stop an associated process, or may damage associated process plant equipment and/or the process de vice itself.

Thus, methods, apparatuses and devices are desired for controlling a process device in customarily unstable process circumstances.

### SUMMARY

A process plant system may include a process device for controlling at least a portion of a process of a process plant and a process device controller. The process device controller may be configured to receive process device characteristic data, generate a process device control signal based on the process device characteristic curve data, wherein the process device characteristic curve data is representative of operational characteristics of the device, and to correct the process device control signal to compensate for deviations of operation of the process device from the operational characteristics of the device.

In another embodiment, a process device controller may include a process device characteristic curve data receiving module stored on a memory that, when executed by a processor, causes the processor to receive device characteristic curve data, wherein the device characteristic curve data is representative of operational characteristics of the process device. The process device controller may also include a control pressure data generation module stored on a memory that, when executed by a processor, causes the processor to generate control pressure data, wherein the process device operates in response to the control pressure data. The process device controller may further include a control pressure correction module stored on a memory that, when executed by a processor, causes the processor to correct the control pressure data, wherein corrected control pressure data compensates for deviations of operation of the process device from the operational characteristics of the process device.

In a further embodiment, a non-transitory computer-readable medium may store computer-readable instructions that, when executed by a processor, cause the processor to control a process device. The non-transitory computer-readable medium may include a process device characteristic curve data receiving module that, when executed by a processor, causes the processor to receive device characteristic curve data, wherein the device characteristic curve data is representative of operational characteristics of the process device. The non-transitory computer-readable medium may also include a control pressure data generation module that, when executed by a processor, causes the processor to generate control pressure data, wherein the process device operates in response to the control pressure data. The non-transitory computer-readable medium may further include a control pressure correction module that, when executed by a processor, causes the processor to correct the control pressure data, wherein corrected control pressure data compensates for deviations of operation of the process device from the operational characteristics of the process device.

### BRIEF DESCRIPTION OF THE DRAWINGS

FIG. 1 is a schematic block diagram of an example process control system including a process device controller that uses a combination of a characteristic curve for the device and a proportional, integral and derivative signal value;

FIG. 2 depicts an example proportional-integral-derivative controller for use with a process device;

FIG. 3 depicts a process device characteristic curve along with an associated correction band width;

FIG. 4 depicts a flow diagram for an example process device control;

FIG. 5 depicts block diagram for an example process device controller; and

FIG. 6 depicts a flow diagram for an example process device control.

### DETAIL DESCRIPTION

Methods, apparatuses and systems are provided to control a process device by combining process device characteristic curve based control with PID control. The methods, apparatuses and systems may provide a more stable process device pressure control, avoiding process medium pressure peaks and/or process medium pressure drops. In addition, faster process device response time may be provided.

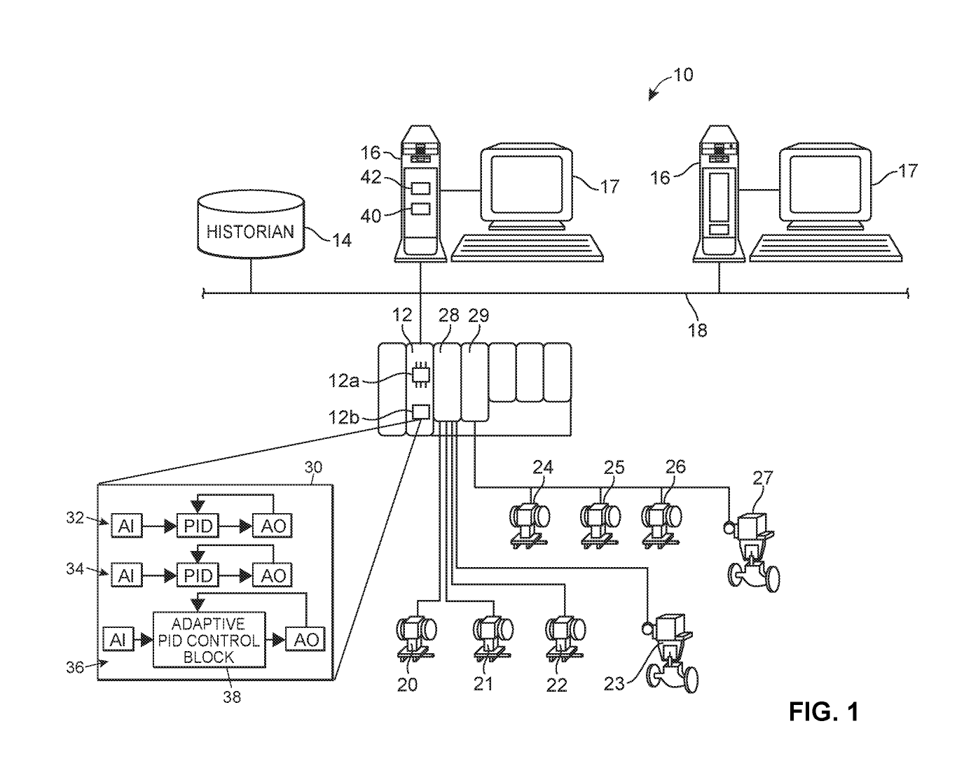

Referring now to FIG. 1, a process control system 10 for use in controlling, for example, an industrial process such as a refinery, a drug manufacturing process, a power plant, etc., includes a process controller 12 connected to a data historian 14 and to one or more host workstations or computers 16 via a communications network 18. The host workstations or computers 16 may be any type of personal computers, workstations, etc., each having a display screen 17. The controller 12 may also be connected to field devices 20-27 via input/output (I/O) cards 28 and 29. The communications network 18 may be, for example, an Ethernet communications network or any other suitable or desirable communications network. The data historian 14 may be any desired type of data collection unit having any desired type of memory and any desired or known software, hardware or firmware for storing data. The controller 12, which may be, by way of example, a DeltaV™ controller or ER5000 controller sold by Emerson Process Management, may be communicatively connected to the field devices 20-27 using any desired hardware and software associated with, for example, standard 4-20 ma devices and/or any smart communication protocol such as the FOUNDATION® Fieldbus protocol, the HART® protocol, etc.

The field devices 20-27 may be any type of process devices, such as sensors, valves, regulators, transmitters, positioners, etc. which perform a physical function within the process and/or which measure a process variable. The I/O cards 28 and 29 may be any types of I/O devices conforming to any desired communication or controller protocol. In the embodiment illustrated in FIG. 1, the field devices 20-23 may be standard 4-20 ma devices that communicate over analog lines to the I/O card 28, or may be HART devices that communicate over combined analog and digital lines to the I/O card 28. The field devices 24-27 may be smart devices, such as Fieldbus field devices, that communicate over a digital bus to the I/O card 29 using Fieldbus protocol communications. Generally, the Fieldbus protocol may be an all-digital, serial, two-way communication protocol that provides a standardized physical interface to a two-wire loop or bus which interconnects field devices. The Fieldbus protocol may provide, in effect, a local area network for field devices within a process, which may enable the field devices to perform process control functions using, for example, function blocks (e.g., PID function blocks) defined according to the Fieldbus protocol, at locations distributed throughout a process facility, and to communicate with one another before and after performance of these process control functions to implement an overall control strategy. Alternatively, or additionally, the field devices 20-27 may conform to any other desired standards or protocols, including any wired or wireless standards or protocols, and any protocols now existing or developed in the future.

The controller 12 may include a processor 12a that may implement or executes one or more process control routines (e.g., modules), which may include control loops (e.g., PID loops) or portions of control loops, stored in a computer readable memory 12b, and may communicate with the devices 20-27, the host computers 16 and/or the data historian 14 to control a process in any desired manner.

It should be noted that any of the control routines or elements described herein may have parts thereof implemented or executed by processors in different controllers or other devices, such as in one or more of the field devices 20-27 if so desired. Likewise, the control routines or elements described herein to be implemented within the process control system 10 may take any form, including software, firmware, hardware, etc. A process control element can be any part or portion of a process control system including, for example, a routines a block or a module stored on any computer readable medium. Control routines, which may be modules or any part of a control procedure, such as a subroutine, parts of a subroutine (such as lines of code), etc. may be implemented in any desired software format, such as using ladder logic, sequential function charts, function block diagrams, or any other software programming language or design paradigm. Likewise, the control routines may be hard-coded into, for example, one or more EPROMs, EEPROMs, application specific integrated circuits (ASICs), or any other hardware or firmware elements. Still further, the control routines may be designed using any design tools, including graphical design tools or any other type of software/hardware/firmware programming or design tools. As a result, it will be understood that the controller 12 may be configured to implement a control strategy or a control routine in any desired manner.

The controller 12 may implement a control strategy using what are commonly referred to as function blocks, wherein each function block is a part (e.g., a subroutine) of an overall control routine, and may operate in conjunction with other function blocks (via communications called links) to implement process control loops within the process control system 10. Function blocks typically perform one of an input function, such as that associated with a transmitter, a sensor or other process parameter measurement device, a control function, such as that associated with a control routine that performs PID, fuzzy logic, etc. control, or an output function which controls the operation of some device, such as a valve or a regulator, to perform some physical function within the process control system 10. Hybrid and other types of function blocks exist. Function blocks may be stored in and executed by the controller 12, which is typically the case when these function blocks are used for, or are associated with standard 4-20 ma devices and some types of smart field devices such as HART and Fieldbus devices. Alternatively, or additionally, the function blocks may be stored in and implemented by the field devices themselves, which can be the case with some types of Fieldbus devices. While the description of the control system is provided herein using a function block control strategy, the control strategy or control loops or modules could also be implemented or designed using other conventions, such as ladder logic, sequential function charts, etc. or using any other desired programming language or paradigm.

As illustrated by the exploded block 30 of FIG. 1, the controller 12 may include a number of control loops 32, 34 and 36, with the control loop 36 being illustrated as including an adaptive control routine or block 38. Each of the control loops 32, 34 and 36 is typically referred to as a control module. The control loops 32, 34 and 36 are illustrated as performing single loop control using a single-input/single-output PID control block connected to appropriate analog input (AI) and analog output (AO) function blocks, which may be associated with process control devices such as valves, with measurement devices such as temperature and pressure transmitters, or with any other device within the process control system 10. In the example system of FIG. 1, the adaptive control loop 36 includes the adaptive PID control block 38 which operates to adaptively determine and provide tuning parameters to a typical PID routine to adapt operation of the PID control routine during the on-line operation of the control loop 36 when controlling a process, e.g., when controlling the operation of a process using valves and/or other control devices which control a physical parameter of the process, based on measurement signals, such as sensor signals, which are indicative of measured or sensed parameters of the process. While the control loops 32, 34 and 36 are illustrated as performing PID control having an input communicatively connected to one AI function block and an output communicatively connected to one AO function block, the control loops 32, 34 and 36 could include more than a single input and a single output, and the inputs and outputs of these control loops may be connected to any other desired function blocks or control elements to receive other types of inputs and to provide other types of outputs. Moreover, the adaptive control block 38 may implement other types of control strategies, such as PI control, PD control, neural network control, fuzzy logic control, model predictive control or any type of feedforward/feedback control technique.

It shall be understood that the function blocks illustrated in FIG. 1, such as the PID function blocks and the adaptive PID function block 38, which itself can be implemented as one or more interconnected function blocks, can be executed by the controller 12 or, alternatively, can be partially or entirely located in and executed by any other suitable processing device(s), such as one of the workstations 16, one of the I/O devices 28 and 29, or even one of the field devices 24-27.

As illustrated in FIG. 1, one of the workstations 16 may include one or more adaptation support routines which are used to design, control, implement and/or view the adaptive control block 38 or the control loop 36. For example, the workstation 16 may include a user interface routine 40 that enables a user to input parameters to the adaptive PID control block 38 as described in more detail below, to start, stop and control the functioning of the adaptive control loop 36 or the blocks thereof, to provide set points and other adjustments to the control block 38, etc. Still further, the workstation 16 may include a routine or a block 42 that performs various adaptation functions as described in more detail below to perform continuous process model parameter scheduling as part of an adaptive control procedure.

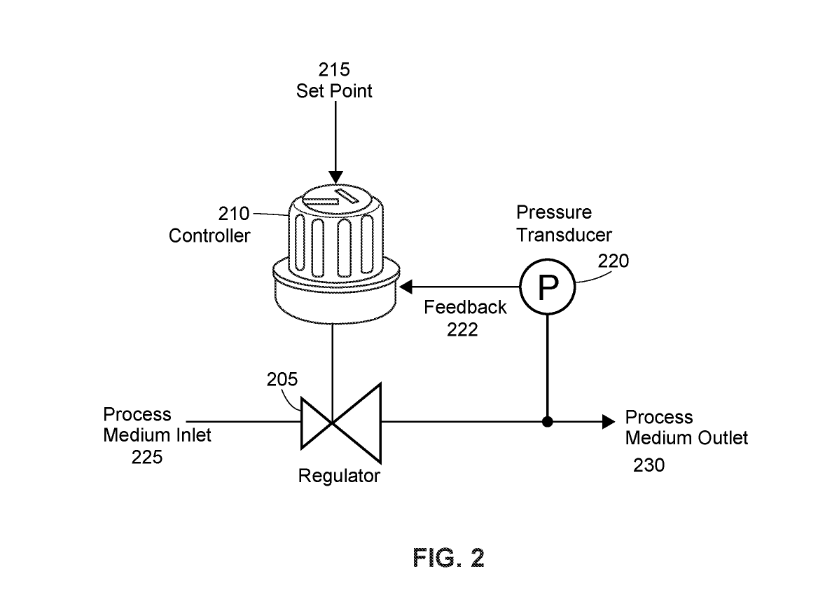

Turning to FIG. 2, a process control system 200 may include a process device 205 (e.g., a regulator, sensor or a valve 20-27 of FIG. 1) having a process medium input 225 and a process medium output 230. The The process control system 200 may further include a controller 210 (e.g., proportional-integral-derivative (PID) controller) and a pressure transducer 220. The controller 210 may receive a set point input 215 and a feedback signal 222. The process control system 200 may be, for example, similar to a portion of the process control system 100 of FIG. 1. The set point input 215 may be representative of, for example, a desired pressure associated with the process medium output 230. While not shown in FIG. 2, the process control system 200 may also, or alternatively, include a pressure transducer connected to the process medium input 225, and a feedback signal may be provided to the controller that is representative of, for example, a pressure associated with the process medium input 225.

Closed loop electronic pressure control may be used to maintain a process medium outlet 230 pressure of a process device 200 relatively constant, and independent from flow and process medium inlet 225 pressure variations. The controller 210 (e.g., electronic controller) may be, for example, integrated into a programmable logic controller (PLC) or computer controlled applications to generate flexible pressure cycles. Closed loop control may be used, for example, in test stands and sophisticated pressure supply systems. The primary components of a closed loop control may be a controller 210 (e.g., an electronics “controller”), a pressure control valve 205 (e.g., a “regulator”), and a pressure transducer 220. A pressure transducer 220 may, for example, measure a pressure of associated process medium (e.g., process medium output 230) and may transmit the pressure value (e.g. feedback signal 222) back to the controller 210. The controller 210 may compare the pressure value 222 with a set point 215, and may, for example, provide an output signal to the regulator 205 to minimize a difference between the set point 215 and a current value (e.g., a process medium output pressure error). Industrial controllers (e.g., controller 210) may use a PID (Proportional-Integral-Derivative) algorithm to implement a closed loop control.

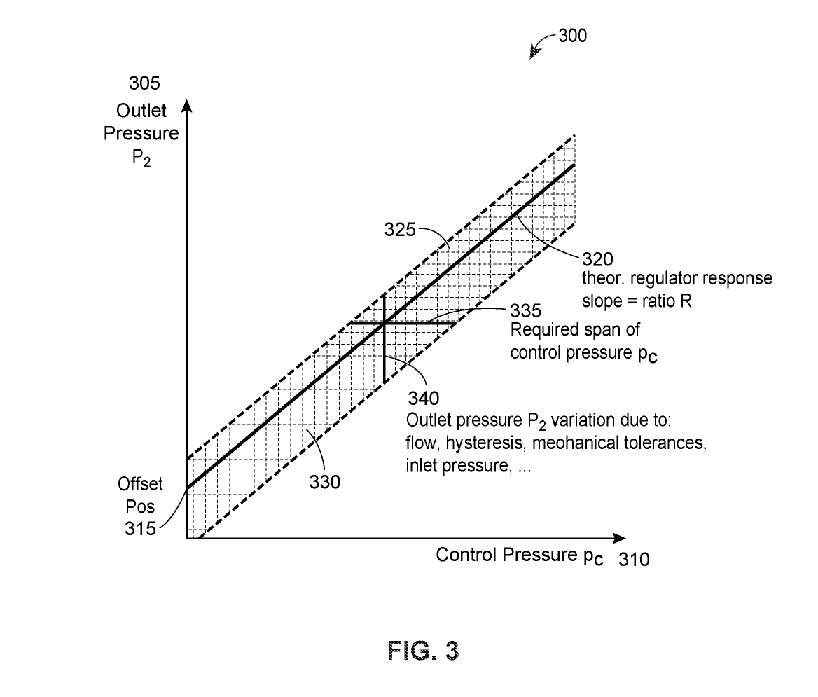

With reference to FIG. 3, a process device operation graph 300 may include a characteristic curve 320 along with an associated correction band width 325, 330 is illustrated. The process device operation graph 300 may, for example, be representative of a characteristic operation of the process device 205 of FIG. 2. The characteristic curve 320 may be, for example, a linear representation of a relation between a process device control pressure (P_{C}) 310 and a process device outlet pressure (P₂) 305, with an offset 315. A slope of the characteristic curve (P₂/P_{C}) and the offset 315 may be known for each process device (e.g., valve or regulator) type, and may be used to evaluate a control pressure (P_{C}) which nearly generates a required outlet pressure 305.

P₂=P_{OS} R×P_{C} [Equation 1]—(illustrated by the solid line in FIG. 3)

A process device controls algorithm may combine use of a process device characteristic curve along with a PID loop to, for example, solve and minimize the above mentioned overshoot/undershoot problems associated with typical PID based controls. For example, a regulator (or valve) control may determine that for 3.0% of a given pressure range, roughly 20-40% of the control pressure range (e.g., as illustrated in FIG. 3) may be used, and not 0% or 100%.

A PID algorithm may, for example, determine a correction value P_{PID} for the control pressure 310 to correct for process interruptions and/or process device instability (e.g., process device flow, process device inlet pressure, process device hysteresis, mechanical tolerances, and other effects). A value of P_{PID} may be, for example, a small fraction (e.g., 10-30%, shaded area in FIG. 3) of the total control pressure 310, so that a value can be limited to avoid the associated process device control getting far away from a stable process device operation point. Thereby, using a combination of a process device characteristic curve and a PID loop to control the process deice may reduce the overshoot/undershoot problems described above.

P₂=P_{OS} R×(P_{C}+P_{PD}) [Equation 2]—(illustrated by the shaded area in FIG. 3)

As a another advantage of using a combination of a characteristic curve and a PID loop to control a process device, a control speed may be increased in case of, for example, a step response. Thus, the process device control may react more stably to process interruptions.

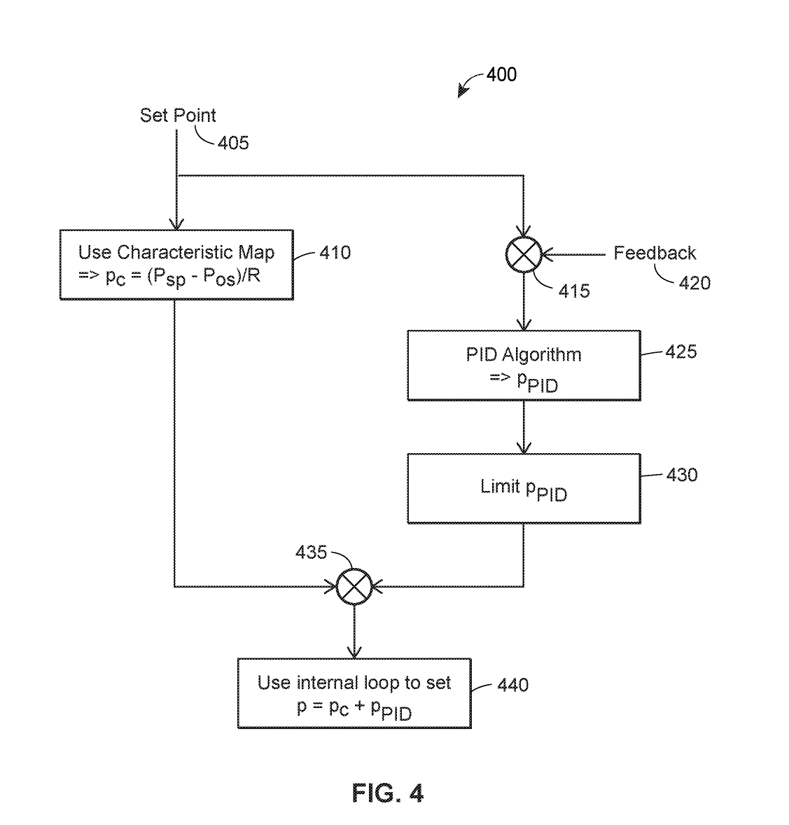

Turning to FIG. 4, a flow diagram for an example process device control 400 may include a using a process device characteristic curve (e.g., process device characteristic curve 320 of FIG. 3) to control a process device when a set point 405 is greater than, or equal to a control pressure (P_{C}), where P_{C} is equal to (P_{SP}−P_{OS})/R (block 410). Otherwise, when a sum of the set point 405 and a feedback 420 (e.g., a process medium output pressure) (block 415) is determined to be greater than, or equal to, a P_{PID} value (block 425), the process device control 400 may use a PID Algorithm and a limit on an associated P_{PID} signal value (block 430). In either event, the process device control 400 may sum the characteristic curve control value (block 410) with the limited P_{PID}value (block 430) (block 435) to produce a corrected process device control pressure (P=P_{C}+P_{PID}) (block 440). Thereby, a combination of PID control and characteristic curve control may use known regulator parameters to support the controls algorithm to make associated process device response faster and more stable.

Abbreviations used in the above description of the process device control 400 include: P₁—inlet pressure process medium; P₂—outlet pressure process medium; P_{OS}—Offset pressure; P_{C}—control pressure (pressure at the air loader); R—ratio=P₂/P_{C}; and P_{PID}—correction of the control pressure calculated by a PID algorithm.

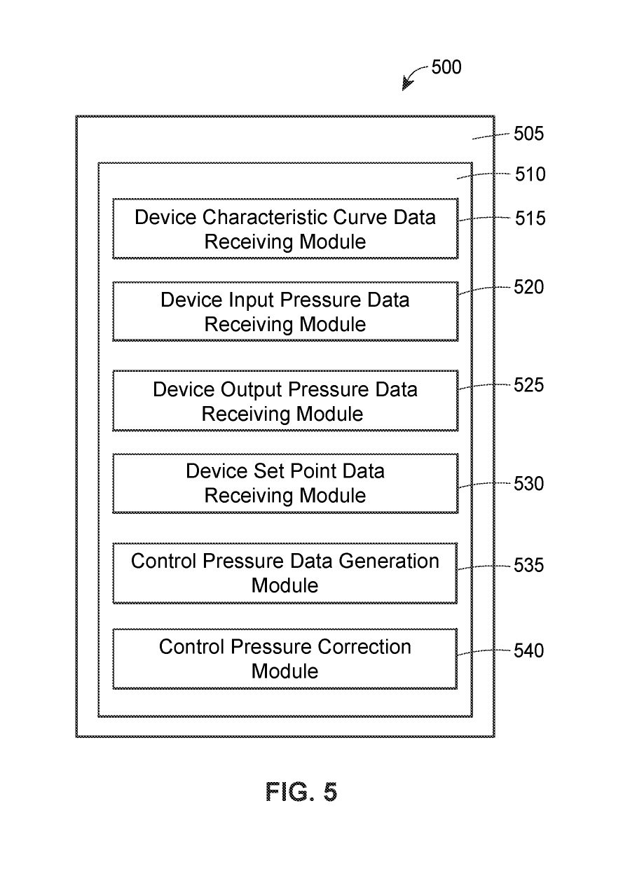

With reference to FIG. 5, a block diagram 500 is depicted for an example process device controller 505. The process device control 505 may include a device characteristic curve data receiving module 515, a device input pressure data receiving module 520, a device output pressure data receiving module 525, a device set point data receiving module 530, a control pressure data generation module 535, and a control pressure correction module 540 stored on, for example, a computer-readable medium 515 as a set of computer-readable instructions. The process device control 505 may be similar to, for example, any one of the controllers of FIG. 1 or 2.

One or more of the modules, elements, processes and/or devices illustrated in FIGS. 1, 2 and 5 may be combined, divided, re-arranged, omitted, eliminated and/or implemented in any other way. Further, the device characteristic curve data receiving module 515, the device input pressure data receiving module 520, the device output pressure data receiving module 525, the device set point data receiving module 530, the control pressure data generation module 535, the control pressure correction module 540, and/or, more generally, the process device control 505 may be implemented by hardware, software, firmware and/or any combination of hardware, software and/or firmware. Thus, for example, any of the device characteristic curve data receiving module 515, the device input pressure data receiving module 520, the device output pressure data receiving module 525, the device set point data receiving module 530, the control pressure data generation module 535, the control pressure correction module 540, and/or, more generally, the process device control 505 may be implemented by one or more circuit(s), programmable processor(s), application specific integrated circuit(s) (ASIC(s)), programmable logic device(s) (PLD(s)) and/or field programmable logic device(s) (FPLD(s)), etc. Further still, the process device control 505 may include one or more elements, processes and/or devices in addition to, or instead of, those illustrated in FIGS. 1, 2 and 5, and/or may include more than one of any or all of the illustrated modules, elements, processes and devices.

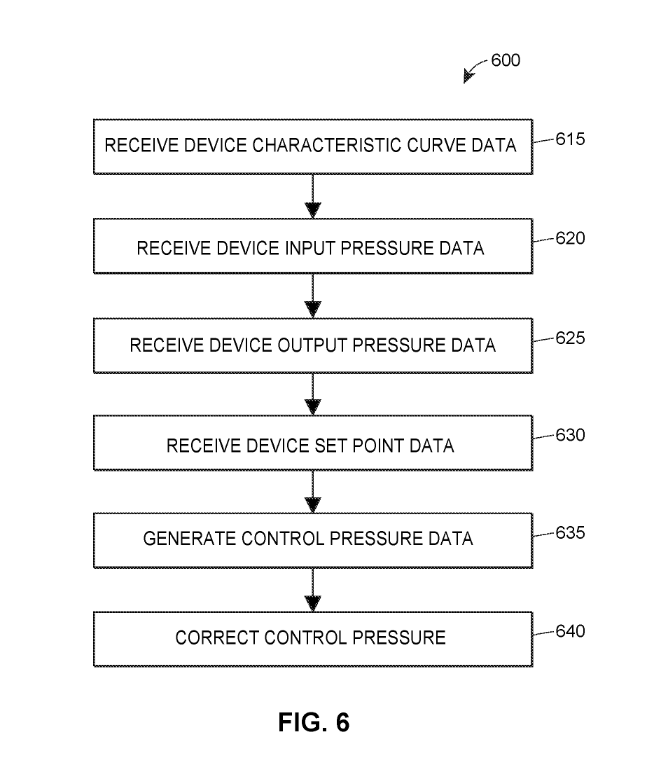

Turning to FIG. 6, a flow diagram 600 for an example process device control (e.g., process device control 500 of FIG. 5) may include a processor (e.g., processor 12a of FIG. 1) that may execute the device characteristic curve data receiving module 515 to cause the processor 12a to receive device characteristic curve data (block 615). The device characteristic curve data may be representative of operational characteristics of the process device.

The processor 12a may execute the control pressure data generation module 535 to cause the processor 12a to generate control pressure data (block 635). The process device may operate in response to the control pressure data.

The processor 12a may execute the control pressure correction module 540 to cause the processor 12a to correct the control pressure data (block 640). The corrected control pressure data may compensate for deviations of operation of the process device from the operational characteristics of the process device.

The processor 12a may execute the device input pressure data receiving module 520 to cause the processor 12a to receive device input pressure data (block 620). The control pressure data may be based, at least in part, on the process device input pressure data.

The processor 12a may execute the device output pressure data receiving module 525 to cause the processor 12 a to receive process device output pressure data (block 625). The control pressure data may be based, at least in part, on the process device output pressure data.

The processor 12a may execute the device set point data receiving module 530 to cause the processor 12a to receive process device set point data (block 630). The control pressure data may be based, at least in part, on the process device set point data.

FIGS. 4 and 6 are flowcharts representative of example processes that may be carried out to implement the process deice controls of FIGS. 1, 2 and 5 to control a pneumatic actuator and/or monitor a corresponding valve. More particularly, the example processes of FIGS. 4 and 6 may be representative of machine readable instructions that comprise a program for execution by a processor of a computing device (e.g., controller 500). The program may be embodied in software stored on a tangible computer readable medium such as a CD-ROM, a floppy disk, a hard drive, a digital versatile disk (DVD), a BluRay disk, or a memory associated with the processor. Alternatively, some or all of the example processes of FIGS. 4 and 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, one or more of the example operations of FIGS. 4 and 6 may be implemented manually or as any combination(s) of any of the foregoing techniques, for example, any combination of firmware, software, discrete logic and/or hardware. Furthermore, although the example processes are described primarily with reference to the process device control 500 of FIG. 5, many other methods of implementing the example processes of FIGS. 4 and 6 may alternatively be used. For example, the order of execution of the blocks may be changed, and/or some of the blocks described may be changed, eliminated, or combined. Additionally, all or any portion of each of the example processes of FIGS. 4 and 6 may be performed sequentially and/or in parallel by, for example, separate processing threads, processors, devices, discrete logic, circuits, etc.

As mentioned above, the example processes of FIGS. 4 and 6 may be implemented using coded instructions (e.g., computer-readable instructions) stored on a tangible (e.g., a non-transitory) computer-readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer-readable medium is expressly defined to include any type of computer-readable storage and to exclude propagating signals. Additionally or alternatively, the example processes of FIGS. 4 and 6 may be implemented using coded instructions (e.g., computer-readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

While various functions and/or systems of field devices have been described herein as “modules,” “components,” or “function blocks,” it is noted that these terms are not limited to single, integrated units. Moreover, while the present invention has been described with reference to specific examples, those examples are intended to be illustrative only, and are not intended to limit the invention. It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

What is claimed is:

1. A process plant system, the system comprising:
a process device for controlling at least a portion of a process of a process plant; and
a process device controller configured to:
receive process device characteristic data;
generate a process device control signal based on the process device characteristic curve data, wherein the process device characteristic curve data is representative of operational characteristics of the device; and
to correct the process device control signal to compensate for deviations of operation of the process device from the operational characteristics of the device.

2. The system of claim 1, further comprising:
a process device input pressure sensor to generate process device input pressure data, wherein the process device control signal is based, at least in part, on the process device input pressure data.

3. The system of claim 1, further comprising:
a process device output pressure sensor to generate process device output pressure data, wherein the process device control signal is based, at least in part, on the process device input pressure data.

4. The system of claim 1, further comprising:
a process device set point data input, wherein the process device control signal is based, at least in part, on the process device set point data.

5. The system of claim 1, further comprising:
a proportional-integral-derivative controller, wherein the process device control signal is corrected, based on process device output pressure data and process device set point data, using the proportional-integral-derivative controller, and wherein a corrected process device control signal is between 0.8 times and 1.2 times the process device control signal.

6. The system of claim 1, wherein the process device is a valve having a pneumatic actuator, and the process device characteristic curve data is representative of a relationship between the process device control signal and a position of the pneumatic actuator.

7. A process device controller, comprising:
a process device characteristic curve data receiving module stored on a memory that, when executed by a processor, causes the processor to receive device characteristic curve data, wherein the device characteristic curve data is representative of operational characteristics of the process device;
a control pressure data generation module stored on a memory that, when executed by a processor, causes the processor to generate control pressure data, wherein the process device operates in response to the control pressure data; and
a control pressure correction module stored on a memory that, when executed by a processor, causes the processor to correct the control pressure data, wherein corrected control pressure data compensates for deviations of operation of the process device from the operational characteristics of the process device.

8. The controller of claim 7, further comprising:
a process device input pressure data receiving module stored on a memory that, when executed by a processor, causes the processor to receive device input pressure data, wherein the control pressure data is based, at least in part, on the process device input pressure data.

9. The device of claim 7, further comprising:
a process device output pressure data receiving module stored on a memory that, when executed by a processor, causes the processor to receive process device output pressure data, wherein the control pressure data is based, at least in part, on the process device output pressure data.

10. The device of claim 7, further comprising:
a process device set point data receiving module stored on a memory that, when executed by a processor, causes the processor to receive process device set point data, wherein the control pressure data is based, at least in part, on the process device set point data.

11. The device of claim 7, wherein the process device control data correction module is a proportional-integral-derivative control.

12. The device of claim 11, wherein the control pressure data is based at least in part on process device set point data, and wherein the corrected control pressure data is based at least in part on process device outlet pressure data.

13. The device of claim 7, wherein the corrected control pressure data is between 0.8 times and 1.2 times the process device characteristic curve data.

14. A non-transitory computer-readable medium storing computer-readable instructions that, when executed by a processor, cause the processor to control a process device, the non-transitory computer-readable medium comprising:
a process device characteristic curve data receiving module that, when executed by a processor, causes the processor to receive device characteristic curve data, wherein the device characteristic curve data is representative of operational characteristics of the process device;
a control pressure data generation module that, when executed by a processor, causes the processor to generate control pressure data, wherein the process device operates in response to the control pressure data; and
a control pressure correction module that, when executed by a processor, causes the processor to correct the control pressure data, wherein corrected control pressure data compensates for deviations of operation of the process device from the operational characteristics of the process device.

15. The non-transitory computer-readable medium of claim 14, further comprising:
a process device input pressure data receiving module that, when executed by a processor, causes the processor to receive device input pressure data, wherein the control pressure data is based, at least in part, on the process device input pressure data.

16. The non-transitory computer-readable medium of claim 14, further comprising:
a process device output pressure data receiving module that, when executed by a processor, causes the processor to receive process device output pressure data, wherein the control pressure data is based, at least in part, on the process device output pressure data.

17. The non-transitory computer-readable medium of claim 14, further comprising:
a process device set point data receiving module that, when executed by a processor, causes the processor to receive process device set point data, wherein the control pressure data is based, at least in part, on the process device set point data.

18. The non-transitory computer-readable medium of claim 14, wherein the process device control data correction module is a proportional-integral-derivative control.

19. The non-transitory computer-readable medium of claim 18, wherein the control pressure data is based at least in part on process device set point data, and wherein the corrected control pressure data is based at least in part on process device outlet pressure data.

20. The non-transitory computer-readable medium of claim 14, wherein the corrected control pressure data is between 0.8 times and 1.2 times the process device characteristic curve data.
